(19) United States
(12) Patent Application Publication
(10) Pub. No.: US 2013/0127795 A1
(43) Pub. Date: May 23, 2013

(54) DISPLAY APPARATUS AND CONTROL METHOD THEREOF

(71) Applicants: Chih-Yung Hsu, Hsinchu County (TW); Kai-I Dai, Taoyuan County (TW); Ying-Neng Huang, Taichung City (TW); Wan-Ju Chang, Hsinchu County (TW)

(72) Inventors: Chih-Yung Hsu, Hsinchu County (TW); Kai-I Dai, Taoyuan County (TW); Ying-Neng Huang, Taichung City (TW); Wan-Ju Chang, Hsinchu County (TW)

(73) Assignee: NOVATEK MICROELECTRONICS CORP., Hsinchu (TW)

(21) Appl. No.: 13/366,366

(22) Filed: Feb. 6, 2012

(30) Foreign Application Priority Data
Nov. 22, 2011 (TW) 100142685

(51) Int. Cl. G09G 5/00

(52) U.S. Cl. 345/204

(57) ABSTRACT

A display apparatus and a control method thereof are provided. The display apparatus includes a display panel, a detection circuit, and a control circuit. The display panel is configured to display images. The detection circuit is configured to detect a noise influencing a display apparatus, and generate a detection signal in response to the noise when the noise is detected. The control circuit is coupled to the detection circuit and the display panel, and configured to maintain an image displayed by the display panel according to the detection signal until the noise disappears. In this way, when the display apparatus is influenced by a noise, the display panel can keep displaying an image displayed before the influence.

### CROSS-REFERENCE TO RELATED APPLICATION

This application claims the priority benefit of Taiwan application serial no. 100142685, filed on Nov. 22, 2011. The entirety of the above-mentioned patent application is hereby incorporated by reference herein and made a part of this specification.

### BACKGROUND OF THE INVENTION

1. Field of the Invention

The present invention generally relates to a display apparatus and a control method thereof, in particular, to a display apparatus capable of maintaining an image displayed before influence and a control method thereof.

2. Description of Related Art

With the coming of the information age, display apparatuses are applied in may applications, such as television screens, computer screens, electronic-book readers, tablet computers, and mobile phones. In addition, by the visual presentation provided by a display apparatus, it is easier and more convenient for a user to obtain information. Further, with the popularization of mobile apparatuses, a lot of information including movies, television programs, short videos, webpage information, and electronic books can be viewed more rapidly and conveniently.

Generally speaking, a display apparatus displays a corresponding image according to a received signal. However, when a noise exists, a signal received by the display apparatus may be incorrect, which makes an image presented by the display apparatus be different from the expected one, thereby affecting experience of a viewing user. In addition, with the environment of use becoming complex, the display apparatus is more likely to be influenced by a noise, so that how to control the operation of the display apparatus being influenced by a noise is a big issue.

### SUMMARY OF THE INVENTION

Accordingly, the present invention is directed to a display apparatus capable of maintaining an image displayed before influence and a control method thereof.

The present invention provides a control method of a display apparatus. The control method includes detecting a noise influencing the display apparatus. The control method further includes: when the noise is detected, generating a detection signal in response to the detected noise. The control method further includes: maintaining an image displayed by the display apparatus according to the detection signal until the noise disappears.

The present invention provides a display apparatus. The display apparatus includes a display panel, a detection circuit, and a control circuit. The display panel is configured to display images. The detection circuit is configured to detect a noise influencing the display apparatus, and generate a detection signal in response to the noise when the noise is detected. The control circuit is coupled to the detection circuit and the display panel, and configured to maintain an image displayed by the display panel according to the detection signal until the noise disappears.

In an embodiment of the present invention, the noise is an electrostatic noise, and the detection circuit is an electrostatic discharge (ESD) circuit and configured to detect the electrostatic noise. The ESD circuit generates the detection signal in response to the detected electrostatic noise.

In an embodiment of the present invention, the display apparatus operates according to a plurality of control signals. The detection circuit detects whether waveforms of the control signals are consistent with specific formats. If the waveform of any control signal is not consistent with the specific format, the detection circuit judges that the display apparatus is influenced by a noise, and generates a detection signal.

In an embodiment of the present invention, the display panel includes a plurality of data lines, a plurality of scan lines, a plurality of control units, and a plurality of display units. A control terminal of each control unit is coupled to a corresponding scan line, an input terminal of each control unit is coupled to a corresponding data line, and an output terminal of each control unit is coupled to a corresponding display unit. The control circuit includes a timing control circuit, a source drive circuit, and a gate drive circuit. The timing control circuit is configured to generate a source control signal and a gate control signal. The source drive circuit is coupled to the timing control circuit and the display panel, and configured to output display signals to the input terminals of the control units through the data lines according to the source control signal. The gate drive circuit is coupled to the timing control circuit and the display panel, and configured to output a scan signal to the control terminals of the control units through the scan lines according to the gate control signal. When the detection circuit detects the noise, the source drive circuit temporarily stops outputting the display signals to the input terminals of the control units, and the gate drive circuit temporarily stops outputting the scan signal to the control terminals of the control units.

In an embodiment of the present invention, the source drive circuit receives a video signal, and converts the video signal into the display signals. When the detection circuit detects the noise, the source drive circuit temporarily stops receiving the video signal.

In an embodiment of the present invention, in a first scan cycle in a first image frame cycle after the noise disappears, the source drive circuit continues to receive the video signal, and converts the video signal into the display signals.

In view of the above, the display apparatus of the present invention detects whether the display apparatus is influenced by a noise through the detection circuit thereof. When the display apparatus is influenced by the noise, an image displayed before the display apparatus is influenced by the noise is maintained until the noise disappears. In this way, a user is prevented from viewing abnormally displayed images.

In order to make the aforementioned features and advantages of the present invention more comprehensible, embodiments are described in detail below with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a function block diagram of a display apparatus according to an embodiment of the present invention.

FIG. 2 is a flow chart of a control method of a display apparatus according to an embodiment of the present invention.

FIG. 3 is a circuit diagram of a display panel of a display apparatus according to an embodiment of the present invention.

FIG. 4 is a timing diagram of a source control signal and a gate control signal when a display apparatus is not influenced by any noise according to an embodiment of the present invention.

FIG. 5 is a timing diagram of a source control signal and a gate control signal when a display apparatus is influenced by a noise according to an embodiment of the present invention.

FIG. 6 is a timing diagram of a source control signal and a gate control signal when a noise influencing a display apparatus disappears according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

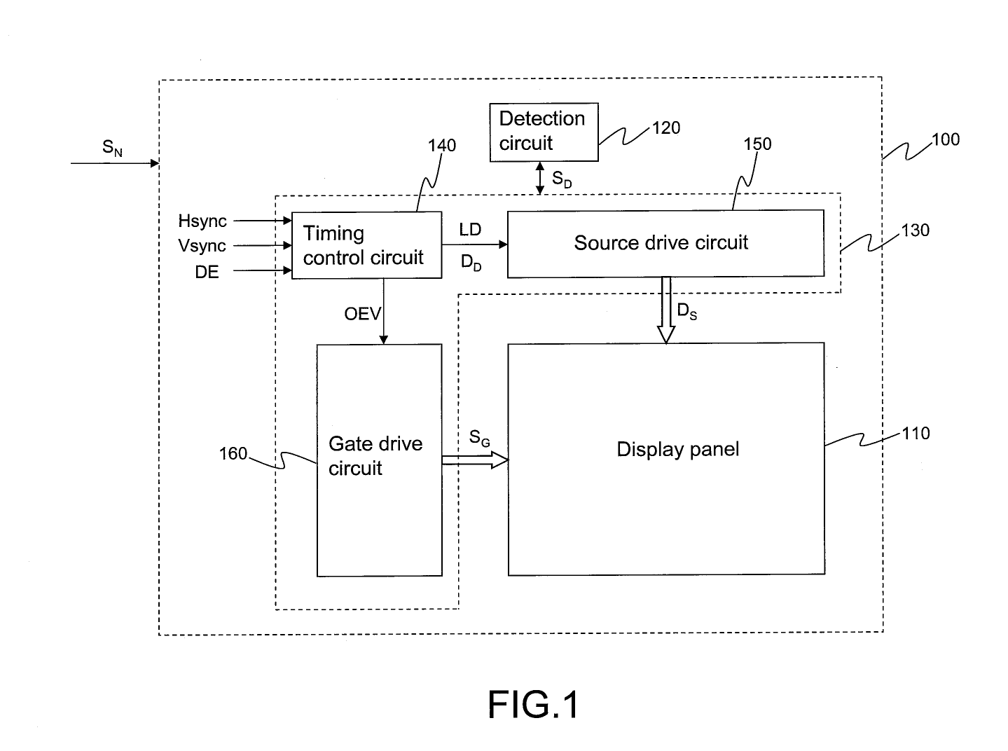

Referring to FIG. 1, FIG. 1 is a function block diagram of a display apparatus 100 according to an embodiment of the present invention. The display apparatus 100 includes a display panel 110, a detection circuit 120, and a control circuit 130. The display panel 110 is configured to display images. The detection circuit 120 is configured to detect a noise S_{N} influencing the display apparatus 100, and generate a detection signal S_{D} in response to the noise S_{N} when the noise S_{N} is detected. The control circuit 130 is coupled to the detection circuit 120 and the display panel 110, and is configured to maintain an image displayed by the display panel 110 according to the detection signal S_{D} until the noise S_{N} disappears. In this way, when the display apparatus 100 is influenced by a noise, the display panel 110 can keep displaying an image displayed before the influence.

In an embodiment of the present invention, the noise S_{N} is an electrostatic noise, and the detection circuit 120 is an ESD circuit and configured to detect the electrostatic noise S_{N}. The ESD circuit 120 generates the detection signal S_{D} in response to the detected electrostatic noise S_{N}. It should be understood that the noise S_{N} may be a noise in forms besides the electrostatic noise, and the present invention is not limited thereto. For example, the noise S_{N} may also be an electromagnetic wave noise or a magnetic field noise.

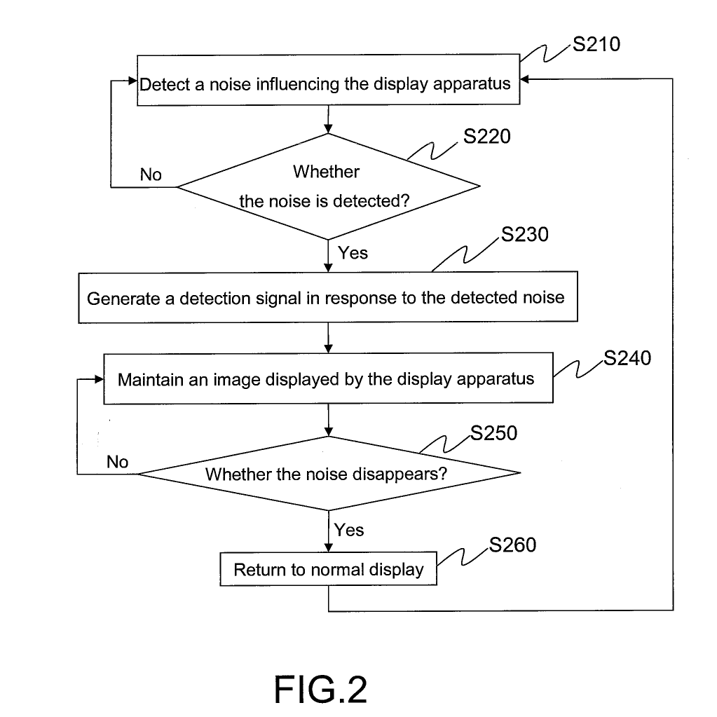

Referring to FIG. 2, FIG. 2 is a flow chart of a control method of a display apparatus according to an embodiment of the present invention. In Step S210, the detection circuit 120 detects a noise S_{N} influencing the display apparatus 100. Then, in Step S220, it is judged whether the noise S_{N} is detected. If the detection circuit 120 does not detect any noise influencing the display apparatus 100, the procedure proceeds to Step S210, so that the detection circuit 120 continues to detect a noise influencing the display apparatus 100. Otherwise, if the detection circuit 120 detects the noise S_{N} influencing the display apparatus 100, the procedure proceeds to Step 230, so that a detection signal S_{D} is generated based on the detected electrostatic noise S_{N}. Then, in Step 5240, the control circuit 130 maintains an image displayed by the display panel 110 according to the detection signal S_{D}. Further, in Step S250, the control circuit 130 judges whether the noise S_{N} disappears according to the detection signal S_{D} generated by the detection circuit 120. If it is judged in Step S250 that the noise S_{N} does not disappear, the control circuit 130 continues controlling the display panel 110 to make the display panel 110 maintain the displayed image; otherwise, if it is judged in Step S250 that the noise S_{N} already disappears, the procedure proceeds to Step S260, the control circuit 130 returns to a normal control mode to make the display panel 110 returns to a normal display mode.

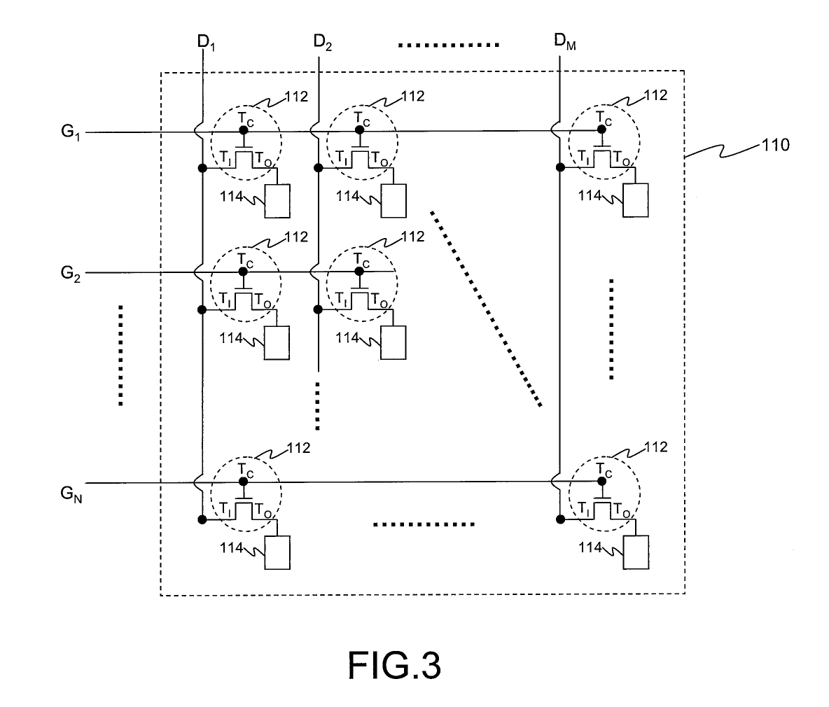

Referring to FIG. 3, FIG. 3 is a circuit diagram of a display panel 100 of a display apparatus according to an embodiment of the present invention. The display panel 110 includes a plurality of data lines D₁ to D_{M}, a plurality of scan lines G₁ to G_{N}, a plurality of control units 112, and a plurality of display units 114. A control terminal T_{C} of each control unit 112 is coupled to a corresponding scan line, an input terminal T₁ of each control unit 112 is coupled to a corresponding data line, and an output terminal T_{O} of each control unit 112 is coupled to a corresponding display unit 114. In an embodiment of the present invention, the display panel 110 is a Liquid Crystal Display (LCD) panel, the control unit 112 is Thin-Film Transistor (TFT), and the display unit 114 is a pixel having liquid crystal molecules. The control terminal T_{C} of the control unit 112 is a gate. The input terminal T_{I} of the control unit 112 is a source. The output terminal T_{O} of the control unit 112 is a drain.

It should be understood that, although an LCD is taken as an example of the display apparatus in the aforementioned embodiments, the present invention may also be applied in other display apparatuses, such as a plasma display and a Cathode Ray Tube (CRT) monitor.

Referring to FIG. 1, in an embodiment of the present invention, the control circuit 130 includes a timing control circuit 140, a source drive circuit 150, and a gate drive circuit 160. The timing control circuit 140 is configured to generate a source control signal LD and a gate control signal OEV. The source drive circuit 150 is coupled to the timing control circuit 140 and the display panel 110. The gate drive circuit 160 is coupled to the timing control circuit 140 and the display panel 110. Referring to FIG. 1 and FIG. 3, when the display apparatus 100 operates in the normal display mode, the source drive circuit 150 receives a video signal D_{D} according to the source control signal LD generated by a timing control circuit 140, and converts the video signal D_{D} into display signals D_{S}. The source drive circuit 150 outputs the display signals D_{S} to the input terminals T_{I} of the control units 112 through the data lines D₁ to D_{M}. Further, the gate drive circuit 160 outputs a scan signal S_{G} to the control terminals T_{C} of the control units 112 in sequence through the scan lines G₁ to G_{N} according to the gate control signal OEV generated by the timing control circuit 140. When the scan signal S_{G} is of high potential, the control unit 112 is turned on, so that the display unit 114 receives the display signal D_{S} from the source drive circuit 150, and presents a corresponding display state in response to the received display signal D_{S}. It should be understood that, although the display signals received by the display units 114 are represented by the same symbol, namely Ds, the display signals D_{S} received by the display units 114 may be different from one another, so that different display states may be presented. Further, when the detection circuit 120 detects the noise S_{N}, the source drive circuit 150 temporarily stops outputting the display signals D_{S} to the input terminals T_{I} of the control units 112, and the gate drive circuit 160 temporarily stops outputting the scan signal S_{G} to the control terminals T_{C} of the control units 112. In this way, the display panel 110 can keep displaying an image displayed before the influence. Further, in an embodiment of the present invention, when the detection circuit 120 detects the noise S_{N}, the source drive circuit 150 temporarily stops receiving the video signal D_{D}.

In an embodiment of the present invention, the display apparatus 100 performs an operation thereof according to a plurality of control signals. For example, the plurality of control signals includes a horizontal synchronization signal Hsync, a vertical synchronization signal Vsync, and a data enable signal DE. The control signals are consistent with corresponding specific formats respectively, so that the display apparatus 100 can operate accordingly. The detection circuit 120 detects whether waveforms of the control signals are consistent with the corresponding specific formats thereof. If the waveform of any control signal is not consistent with the corresponding specific format, the detection circuit 120 judges that the display apparatus 100 is influenced by a noise, and therefore generates the detection signal S_{D}.

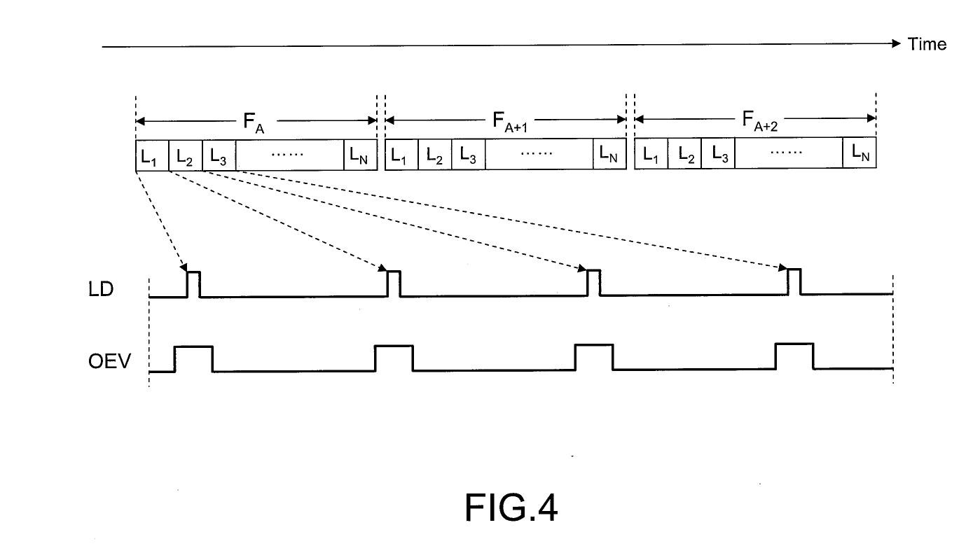

Referring to FIG. 1, FIG. 3, and FIG. 4, FIG. 4 is a timing diagram of the source control signal LD and the gate control signal OEV when the display apparatus 100 is not influenced by the noise S_{N} according to an embodiment of the present invention. When the source control signal LD is of high potential, the source drive circuit 150 receives the video signal D_{D}, and converts the video signal D_{D} into display signals D_{S}. When the gate control signal OEV is of low potential, the gate drive circuit 160 sends the scan signal S_{G} to the control terminals T_{C} of the control units 112 through the scan lines G₁ to G_{N}, so as to turn on the control units 112. Correspondingly, when the source control signal LD is of low potential, the source drive circuit 150 temporarily stops receiving the video signal D_{D}, and stops converting the video signal D_{D} into the display signals D_{S}. When the gate control signal OEV is of high potential, the gate drive circuit 160 stops sending the scan signal S_{G} to the control terminals T_{C} of the control units 112.

When the display apparatus 100 operates, the timing is divided into a plurality of image frame cycles, and in each image frame cycle the display states of the display units 114 are updated once. FIG. 4 shows three image frame cycles F_{A} to F_{A+2}. Further, each of the image frame cycles F_{A} to F_{A+2} is divided into a plurality of scan cycles L₁ to L_{N}. In the scan cycles L₁ to L_{N}, the gate drive circuit 160 transmits the scan signal S_{G} to corresponding scan lines G₁ to G_{N}, so as to update the display states of the display units 114 connected to the scan lines. For example, in the scan cycle L₁, the display state of the display unit 114 connected to the scan line G₁ is updated; in the scan cycle L₂, the display state of the display unit 114 connected to the scan line G₂ is updated; in the scan cycle L_{N}, the display state of the display unit 114 connected to the scan line G_{N} is updated, and so on.

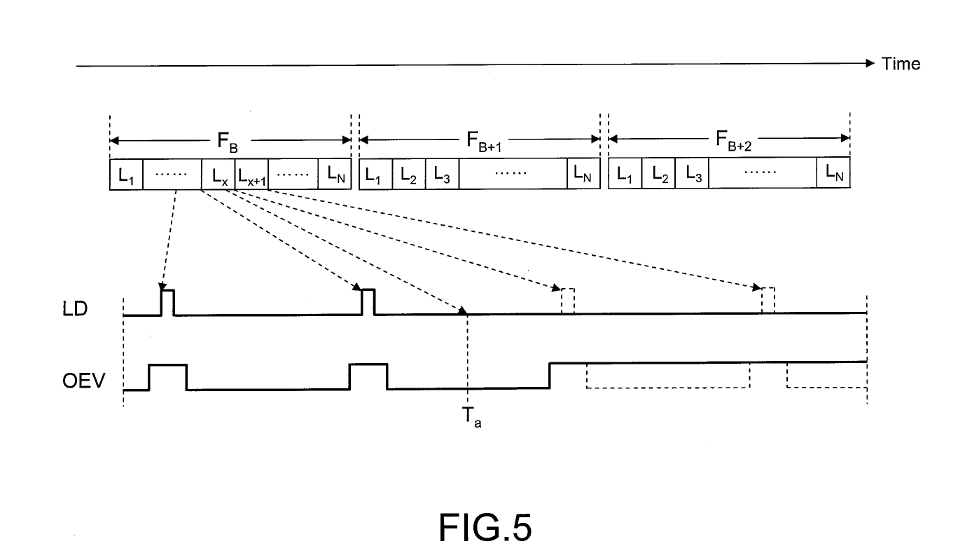

Referring to FIG. 1, FIG. 3, and FIG. 5, FIG. 5 is a timing diagram of the source control signal LD and the gate control signal OEV when the display apparatus 100 is influenced by the noise S_{N} according to an embodiment of the present invention. FIG. 5 shows three other image frame cycles F_{B} to F_{B+2}. At a time point Tₐ within a scan cycle L_{X}, the detection circuit 120 detects the noise S_{N} influencing the display apparatus 100, and therefore generates the detection signal S_{D}. The timing control circuit 140 receives the detection signal S_{D}, therefore makes the source control signal LD maintain low potential after the scan cycle L_{X}, and makes the gate control signal OEV maintain high potential in scan cycles after the scan cycle L_{X}. In this way, after the scan cycle L_{X}, updating of the display states of all of the display units 114 is stopped, so as to make the display panel 110 maintain the image displayed before the influence.

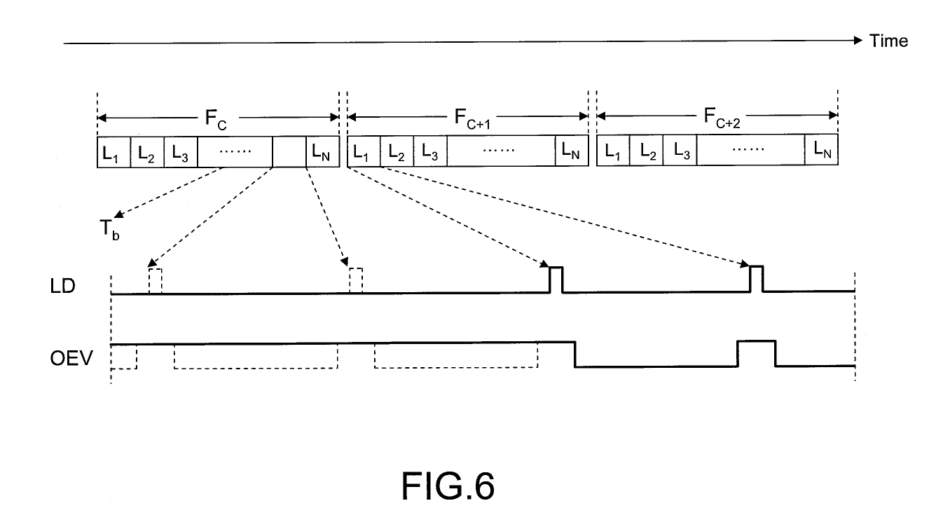

Referring to FIG. 1, FIG. 3, and FIG. 6, FIG. 6 is a timing diagram of the source control signal LD and the gate control signal OEV when the noise influencing the display apparatus 100 disappears according to an embodiment of the present invention. FIG. 6 shows three other image frame cycles F_{C} to F_{C+2}. Before the image frame cycle F_{C}, the display apparatus 100 is influenced by the noise S_{N}, but at a time point T_{b} within the scan cycle L_{C}, the detection circuit 120 detects that the noise S_{N} influencing the display apparatus 100 disappears. In scan cycles after the time point T_{b} and within the image frame cycle F_{C}, the source control signal LD maintains low potential, and the gate control signal OEV maintains high potential. Then, after the noise S_{N} disappears, in the first scan cycle L₁ in the image frame cycle F_{C+1}, the control circuit 130 returns to the normal control mode, so as to raise the potential of the source control signal LD to the high potential and lower the potential of the gate control signal OEV to the low potential. Therefore, in the first scan cycle L₁ in the first image frame cycle (the image frame cycle F_{C+1}) after the noise S_{N} disappears, the source drive circuit 150 continues to receive the video signal D_{D}, and converts the video signal D_{D} into the display signals D_{S}, and the gate drive circuit 160 continues to output the scan signal S_{G} to the control terminals T_{C} of the control units 112. In this way, after the image frame cycle F_{C+1}, the control circuit 130 continues to update the display states of the display units 114, so as to update the image displayed by the display panel 110. The control circuit 130 returns to the normal control mode in the first scan cycle in the first image frame cycle after the noise S_{N} disappears, so that after returning to the normal display mode the display panel 110 can display normal and complete images.

In view of the above, the display apparatus of the present invention detects whether the display apparatus is influenced by a noise through the detection circuit thereof When the display apparatus is influenced by the noise, an image which is displayed before the display apparatus is influenced by the noise is maintained until the noise disappears. In this way, a user is prevented from viewing abnormally displayed images.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control method of a display apparatus, comprising:
detecting a noise influencing the display apparatus;
when the noise is detected, generating a detection signal in response to the detected noise; and
maintaining an image displayed by the display apparatus according to the detection signal until the noise disappears.

2. The control method according to claim 1, wherein the noise is an electrostatic noise, and the step of detecting the noise influencing the display apparatus comprises:
using an electrostatic discharge (ESD) circuit to detect the electrostatic noise;
wherein the ESD circuit generates the detection signal in response to the detected electrostatic noise.

3. The control method according to claim 1, wherein the display apparatus operates according to a plurality of control signals, and the step of detecting the noise influencing the display apparatus comprises:
detecting whether waveforms of the control signals are consistent with specific formats;
wherein if the waveform of any one of the control signals is not consistent with the specific format, it is judged that the display apparatus is influenced by the noise, and the detection signal is generated.

4. The control method according to claim 1, wherein the display apparatus comprises:
a display panel, configured to display images and comprising a plurality of data lines, a plurality of scan lines, a plurality of control units, and a plurality of display units, wherein a control terminal of each control unit is coupled to a corresponding scan line, an input terminal of each control unit is coupled to a corresponding data line, and an output terminal of each control unit is coupled to a corresponding display unit;
a timing control circuit, configured to generate a source control signal and a gate control signal;
a source drive circuit, coupled to the timing control circuit and the display panel, and configured to output display signals to the input terminals of the control units through the data lines according to the source control signal; and
a gate drive circuit, coupled to the timing control circuit and the display panel, and configured to output a scan signal to the control terminals of the control units through the scan lines according to the gate control signal; and
wherein when the noise is detected, the source drive circuit temporarily stops outputting the display signals to the input terminals of the control units, and the gate drive circuit temporarily stops outputting the scan signal to the control terminals of the control units.

5. The control method according to claim 4, wherein the source drive circuit receives a video signal, and converts the video signal into the display signals, and when the noise is detected, the source drive circuit temporarily stops receiving the video signal.

6. The control method according to claim 5, wherein in a first scan cycle in a first image frame cycle after the noise disappears, the source drive circuit continues to receive the video signal, and converts the video signal into the display signals.

7. A display apparatus, comprising:
a display panel, configured to display images;
a detection circuit, configured to detect a noise influencing the display apparatus, and generate a detection signal in response to the noise when the noise is detected; and
a control circuit, coupled to the detection circuit and the display panel, and configured to maintain an image displayed by the display panel according to the detection signal until the noise disappears.

8. The display apparatus according to claim 7, wherein the noise is an electrostatic noise, the detection circuit is an electrostatic discharge (ESD) circuit configured to detect the electrostatic noise, and the ESD circuit generates the detection signal in response to the detected electrostatic noise.

9. The display apparatus according to claim 7, wherein the display apparatus operates according to a plurality of control signals, the detection circuit detects whether waveforms of the control signals are consistent with specific formats, and if the waveform of any one of the control signals is not consistent with the specific format, the detection circuit judges that the display apparatus is influenced by the noise, and generates the detection signal.

10. The display apparatus according to claim 7, wherein the display panel comprises a plurality of data lines, a plurality of scan lines, a plurality of control units, and a plurality of display units, a control terminal of each control unit is coupled to a corresponding scan line, an input terminal of each control unit is coupled to a corresponding data line, and an output terminal of each control unit is coupled to a corresponding display unit;
wherein the control circuit comprises:
a timing control circuit, configured to generate a source control signal and a gate control signal;
a source drive circuit, coupled to the timing control circuit and the display panel, and configured to output display signals to the input terminals of the control units through the data lines according to the source control signal; and
a gate drive circuit, coupled to the timing control circuit and the display panel, and configured to output a scan signal to the control terminals of the control units through the scan lines according to the gate control signal; and
wherein when the detection circuit detects the noise, the source drive circuit temporarily stops outputting the display signals to the input terminals of the control units, and the gate drive circuit temporarily stops outputting the scan signal to the control terminals of the control units.

11. The display apparatus according to claim 10, wherein the source drive circuit receives a video signal, and converts the video signal into the display signals, and when the detection circuit detects the noise, the source drive circuit temporarily stops receiving the video signal.

12. The display apparatus according to claim 11, wherein in a first scan cycle in a first image frame cycle after the noise disappears, the source drive circuit continues to receive the video signal, and converts the video signal into the display signals.
